(19) United States
(12) Patent Application Publication
(10) Pub. No.: US 2024/0210064 A1
(43) Pub. Date: Jun. 27, 2024

(54) ENERGY-SAVING AIR CONDITIONING MONITORING AND CONTROL SYSTEM

(71) Applicants: DAT MINH TRUONG, HO CHI MINH (VN); DUNG TIEN BUI, HO CHI MINH (VN)

(72) Inventors: DAT MINH TRUONG, HO CHI MINH (VN); DUNG TIEN BUI, HO CHI MINH (VN)

(73) Assignee: BENKON CORPORATION, HO CHI MINH (VN)

(21) Appl. No.: 18/093,853

(22) Filed: Jan. 6, 2023

(30) Foreign Application Priority Data
Dec. 22, 2022 (VN) 1-2022-08405

(51) Int. Cl. F24F 11/63; G05B 19/042

(52) U.S. Cl. CPC F24F 11/63; G05B 19/042; G05B 2219/2614

(57) ABSTRACT

The present invention relates to an energy-saving air conditioning monitoring and control system. The system may be supplemental equipped for one or many air conditioning apparatuses which work independently, in group, or in several various groups, using a control signal receiving and retransmitting unit for receiving air conditioning control signal from a conditioner control means, for example from a handheld remote control operated by users in the usual manner to controlling the air conditioning apparatus. The data of the air conditioning control signal and other data such as the data of the instantaneous power and the electric energy consumption, the surrounding environment, the habits of users, transmitted to the server via a Mesh network and gateway(s), to performs processing, analyzing, and calculating to generate and retransmit the air conditioning control signal which is adjusted in comparison with the air conditioning control signal transmitted by the conditioner control means, aiming to achieve at least an energy-saving purpose.

### TECHNICAL FIELD

The present invention relates to an air conditioning monitoring and control system, in particularly, the present invention relates to an energy-saving air conditioning monitoring and control system.

### BACKGROUND

Smart air conditioning apparatuses were appeared on the market in about 2010, and until now there are many different manufacturers join to develop and manufacture the smart air conditioning apparatuses. The smart air conditioning apparatus may aim for several various purposes, such as energy-saving, enhancing the usability, increasing the comfort and user experiences, for example. It can be said that, the conventional smart air conditioning apparatus generally contributes for improving the quality of the air conditioning for users significantly.

However, by the observation of inventors, most of users use the smart air conditioning apparatus or a group of the smart air conditioning apparatuses have not yet fully exploited useful functions of them, while manufacturers may provide smart algorithms for integrating plurality of control modes according to various different purposes for the smart air conditioning apparatus, such as energy-saving mode, bedtime mode, etc., many users may not understand correctly or not use correctly the control modes when referring to their living habits or their actual demands. Some of users, during their use, often unchanged or be slow to change parameters or setting operation mode of the air conditioning apparatus in comparison with the time when they turn on, for example when turning on they may set the temperature very low and keep unchanged until feeling uncomfortable, for example feeling very cold before they perform a change, for example increasing the temperature and decreasing the fan speed.

In addition, the setting of the temperature is very low and the fan speed is very high when turning on the air conditioning apparatus may also happen at many public areas, may be at areas where the adjustment of the operation of the air conditioning apparatus not specifically assigned for anyone, even the operation situation may last while there is no one presented at the area where the air conditioning is employed, for example.

The smart air conditioning apparatuses are also said that they not change the operation mode according to the changes of the factors of surrounding environment or habits of the users.

Because the energy needed to use for the air conditioning, generally for all society is very huge, the energy-saving, or in particularly, the electricity-saving during the using of the air conditioning apparatuses have a very important meaning. Although the smart air conditioning apparatuses may solve a part of the problem of the energy-saving in an individual operation mode of them, the energy-saving in general terms such as an adequately adjustment corresponding to the surrounding environment, habits of users, when there are many air conditioning apparatuses commonly operate in a same space or in a same system, is supposedly that not solved very well.

As for that, there is a need of an air conditioning monitoring and control approach may solve the energy-saving problem or the energy-saving solution which is more overall and optimally.

Furthermore, the old generation air conditioning apparatuses are currently in use with a quite huge number. Due to the lifetime of the air conditioning apparatuses are relatively long, and when it is in a comparison with the development of the intelligent control technologies the lifetime of the air conditioning apparatuses may be said to be very long time. Therefore, as for the air conditioning apparatuses, even the “old generation” smart air conditioning apparatuses, upgrading them is very difficult.

Hence, there is also a need of an air conditioning monitoring and control approach may solve the energy-saving or electricity-saving problem, may be applicable supplemental equipped for existed air conditioning apparatuses, to be for using new control algorithms, for example intelligent control algorithms aimed to the energy-saving.

### SUMMARY

An object of the present invention is to provide an energy-saving air conditioning monitoring and control system, may overcome one or more of the above-mentioned problems.

Another object of the present invention is to provide an energy-saving air conditioning monitoring and control system, may solve the energy-saving problem or the energy-saving solution which is more overall and optimally.

Yet another object of the present invention is to provide an energy-saving air conditioning monitoring and control system, may be supplemental equipped for existed air conditioning apparatuses, to be applicable for using new control algorithms, for example intelligent control algorithms aimed to the energy-saving.

Still another object of the present invention is to provide a conditioning face mounting device and a compact measurement device, are adaptively designed for attaching or mounting to the existed air conditioning apparatus conveniently, and perform the role of network nodes according to Mesh network architecture.

Various objects to be achieved by the present invention are not limited to the aforementioned objects, and those skilled in the art to which the disclosure pertains may clearly understand other objects from the following descriptions.

To achieve one or more above objects, the present invention provides an energy-saving air conditioning monitoring and control system,
wherein the system supplemental equipped for one or many air conditioning apparatuses which work independently, in group, or in several various groups,
the system comprising:
at least one control signal receiving and retransmitting unit is provided corresponding to at least one air conditioning apparatus, for receiving an air conditioning control signal from a conditioner control means, operated by users, sending to said air conditioning apparatus;
at least one measurement component is provided corresponding to said at least one air conditioning apparatus, for measuring at least the instantaneous power and the electric energy consumption of the air conditioning apparatus;
at least one gateway for transceiving data bidirectional with the control signal receiving and retransmitting unit and the measurement component, for receiving at least the data of the air conditioning control signal from said conditioner control means and the data of the instantaneous power and the electric energy consumption of said air conditioning apparatus; and
a server for transceiving data bidirectional with said gateway;
wherein:
the control signal receiving and retransmitting unit and the measurement component are configured to perform the role of network nodes according to Mesh network architecture, wherein the control signal receiving and retransmitting unit or the measurement component transmitting or receiving data with the gateway directly or via intermediate nodes of the Mesh network,
the gateway performs processing at least a part of data transmitted from the control signal receiving and retransmitting unit or the measurement component, and transmits the processed data to the server, and forwards the remaining data transmitted from the control signal receiving and retransmitting unit or the measurement component which has not been processed to the server,
the server performs analysis and calculates based on at least data transmitted from the gateway for providing an air conditioning control information, and transmits the air conditioning control information to the corresponding control signal receiving and retransmitting unit via the gateway,
the control signal receiving and retransmitting unit relies on the air conditioning control information, transmitted from the server, to generate and retransmit an air conditioning control signal to the corresponding air conditioning apparatus,
wherein the air conditioning control signal retransmitted by the control signal receiving and retransmitting unit is basically adjusted in comparison with the air conditioning control signal transmitted by the conditioner control means aiming to achieve at least an energy-saving purpose.

According to an embodiment, said control signal receiving and retransmitting unit provided in the form of a conditioning face mounting device, mounted to a mounting position at a suitable surface in the vicinity of the location receiving the air conditioning control signal from the conditioner control means of the corresponding air conditioning apparatus.

Said conditioning face mounting device may comprise:
a conditioning face mounting device base,
a top cover assembled with the conditioning face mounting device base to form a housing containing components therein,
an air conditioning control signal receiver for receiving the air conditioning control signal from the conditioner control means,
an air conditioning control signal transmitter for retransmitting the air conditioning control signal to the corresponding air conditioning apparatus,
a communication module for transceiving data bidirectional with network nodes of said Mesh network and/or said gateway,
a sensor unit for collecting at least the surrounding environment data.

Preferably, said conditioning face mounting device having the conditioning face mounting device base coupled with magnet member (s) so that the conditioning face mounting device base is attachable on a magnetic plate due to the magnetic attracting force,
wherein the magnetic plate is fixed on said mounting position, thus the conditioning face mounting device is mounted to the mounting position in the manner that easily detachable.

According to an embodiment, said the measurement component is provided in the form of a compact measurement device, arranged at a suitable position for measuring the instantaneous power and the electric energy consumption of the corresponding air conditioning apparatus.

The measurement component in the form of the compact measurement device including a base portion, and a cover portion assembled with the base portion to form a housing containing components therein.

According to an embodiment, the above mentioned system is further configured to collect, store, and analyze habits of users and provide the air conditioning control information in consideration with the habits of users.

Preferably, the above mentioned system is further configured to provide suggestions to users at least one air conditioning mode among air conditioning modes which are pre-set and stored at the server, based on at least the habits of users.

### BRIEF DESCRIPTION OF THE DRAWINGS

FIG. 1 is a schematic diagram view illustrating an energy-saving air conditioning monitoring and control system according to an embodiment of the present invention;

FIG. 2 is an exploded perspective view illustrating a conditioning face mounting device according to an embodiment of the present invention; and

FIG. 3 is an exploded perspective view illustrating a compact measurement device according to an embodiment of the present invention.

### DESCRIPTION OF EMBODIMENTS

Hereinafter, advantages, efficiencies, and inventive concepts of the present invention shall be understood more clearly through the detailed description of the preferred embodiments with reference to the accompanying drawings. In the drawings, same reference numbers are intended to indicate same or equivalent components or elements and commonly used in the whole description, therefore in several drawings or several parts of a drawings may not show one or more reference numbers for a purpose that makes the drawings becoming simplified and facilitating for showing composed components or different inventive concepts of the present invention, in this scenario, relationships between certain components or elements with corresponding reference numbers may be clearly illustrated when referring to other drawings or other components on the drawing. In addition, the components and elements illustrated in the drawings is not complied actual sizes and shapes, several components or elements shall be exaggerated and may be presented by simplified blocks for illustrated purposes and facilitating for descriptive purpose. Therefore, it should be understood that embodiments described herein is only exemplary for fully understanding of the inventive steps and advantages of the present invention, without any limitation of the present invention to the embodiments.

The spatial relatively terms, such as “front”, “rear” “length”, “width”, “height”, “above”, “on”, or the same, may be used herein for descriptive purpose, and, therefore, to describe relationship of a component with other component(s) as illustrated in the drawings. It is obviously that, those terms may be interchangeable by the position or the role for the illustration of actual subject matter according to the present invention, for example, if the illustrated object in the drawings is rotated about 180 degrees for example, components which are described as “front” or “rear” will interchange to each other. Therefore, the spatial relatively terms are used as exemplary for descriptive purpose may be included other meanings indicated for other spatial relationships due to the orientation of the illustrated object, such as the term “front” may encompass “rear”, for example.

In general, the energy-saving air conditioning monitoring and control system is provided aiming to be capable of supplemental equipped for one or many air conditioning apparatuses which work independently, in group, or in several various groups.

Herein, the air conditioning apparatus is basically a device with a function to maintain the room air at a stable setting temperature/expected temperature to provide an environment which is more comfortable for users, the temperature stabilization may be cooling down the air or heating the air. Several two-way air conditioning apparatuses generally include both air cooling function and air heating function, whereas several air conditioning apparatuses have only one function for cooling the air may be called as an air cooling device/air conditioner, or only one function for heating the air may be called as a heater.

Common features of the two-way air conditioning apparatus or conventional air conditioner may include two components which are a condenser unit and an evaporator unit, these two components may be arranged integrally in one package, may be called as a packaged air conditioner or a window air conditioner (mainly used in US market, old generation). If these two components are arranged at two different areas they may be divided into two categories which are wall an air conditioner/ceiling air conditioner, and so called “mother-hold-baby” air conditioner with one condenser unit and plurality of the evaporator units.

In most of the designs the air conditioning apparatus always includes an indoor unit, and may be equipped a control board fixed on the wall, or a handheld remote control (infrared remote control). When using the handheld remote control, the indoor unit of the air conditioning apparatus generally includes a signal receiving face for receiving the air conditioning control signal from the handheld remote control. It is obviously that, the air conditioning apparatus may be controlled by the similar conditioner control means which is operated by users, for example a smartphone device installed a dedicated app, for example.

When the user performs the operation to turn on the air conditioning apparatus, an air conditioning control signal (or a control command) will be transmitted to the air conditioning apparatus to be operated corresponding to setting parameters and/or operating mode according to the control command of the user. Counting from that time, the air conditioning apparatus will generally operate according to the settings of the control command (the initial control command) correctly, until the user proactively changes, for example transmitting a new control command. This has been analyzed that it is difficult to achieve the energy-saving purpose if the user does not have a correct habits or consciousness.

According to an aspect, the present invention approaches to the direction adjusting the operation adapted to settings of the initial control command to optimize the controlling of the air conditioning, that is simultaneously using the control command of the user to precisely response to the actual need of the user, and simultaneously optimizing the operation after that, for example making a soft adjustment between a range of suitable temperatures, appropriately adjusted with changes of the surrounding environment, etc., to achieve expected purpose(s), for example energy-saving.

As such, one or several embodiments of the present invention aiming to provide an energy-saving air conditioning monitoring and control system comprising: at least one control signal receiving and retransmitting unit; at least one measurement component; at least one gateway; and a server.

The control signal receiving and retransmitting unit is provided corresponding to at least one air conditioning apparatus, for receiving air conditioning control signal from the conditioner control means, operated by users, sending to said air conditioning apparatus.

The measurement component is provided corresponding to said at least one air conditioning apparatus, for measuring at least the instantaneous power and the electric energy consumption of the air conditioning apparatus.

The gateway for transceiving data bidirectional with said control signal receiving and retransmitting unit and said measurement component, for receiving at least the data of the air conditioning control signal from said conditioner control means and the data of the instantaneous power and the electric energy consumption of said air conditioning apparatus.

The server for transceiving data bidirectional with said gateway.

According to an embodiment, the control signal receiving and retransmitting unit and the measurement component are configured to perform the role of network nodes according to the Mesh network architecture, wherein the control signal receiving and retransmitting unit or the measurement component transmitting or receiving data with the gateway directly or via intermediate nodes of the Mesh network.

The gateway performs processing at least a part of data transmitted from the control signal receiving and retransmitting unit or the measurement component, and transmits the processed data to the server, and forwards the remaining data transmitted from the control signal receiving and retransmitting unit or the measurement component which has not been processed to the server.

The server performs analyzing and calculating based on at least data transmitted from the gateway for providing an air conditioning control information, and transmits the air conditioning control information to the corresponding control signal receiving and retransmitting unit via the gateway.

The control signal receiving and retransmitting unit relies on air the conditioning control information, transmitted from the server, to generate and retransmit the air conditioning control signal to the corresponding air conditioning apparatus. The air conditioning control signal retransmitted by the control signal receiving and retransmitting unit is basically adjusted in comparison with the air conditioning control signal transmitted by said conditioner control means aiming to achieve at least an energy-saving purpose.

The energy-saving air conditioning monitoring and control system according to the present invention may easily and conveniently equip for the air conditioning apparatus(s), including also the existed air conditioning apparatus. Based on the initial control command of the user, the control signal receiving and retransmitting unit performs controlling the corresponding air conditioning apparatus by any manner or algorithm to optimize the operation of the air conditioning apparatus, the control signal receiving and retransmitting unit may retransmit the air conditioning control signal one, few, or plurality of times during the air conditioning apparatus operating. Due to the retransmitted air conditioning control signal is calculated at the server, not only the information of the initial control command of the user, but also other different information/data is also taken into account in the optimizing of the operation of the air conditioning apparatus, such as the information/data of the instantaneous power, the electric energy consumption for example. By equipping the server, it is capable to collect and store plurality of the additional various information/data by many different manners, for example the information/data of the surrounding environment temperature, the surrounding environment humidity, the temperature range that the user often uses (may be provided by the user via an app or a website associated with the server), the control habit of the user, etc., with the forming of the Mesh network, the energy-saving air conditioning monitoring and the control system according to the present invention may also easily connect, share the information with the various different indoor intelligent devices. As the result, it is capable to calculate and adjust the initial control command, generating a series of new control commands to optimize the operation of the air conditioning apparatus not only considering the initial control command of the user but also considering plurality of the associated factors.

It is easy to see that, when deploying the energy-saving air conditioning monitoring and control system according to the present invention over a large-scale area, the system may cover plurality of the air conditioning apparatus or plurality group of the air conditioning apparatus, one or plurality of the air conditioning apparatus or one or plurality of group of the air conditioning apparatuses commonly use a gateway. That means, there may be many or so many air conditioning apparatuses and the smaller number of the gateways, however there may have only one server which is used or one central server system. Therefore, the processing and calculating workload is carried out at the server may be very huge, for ensuring the real time response or reducing the delay are problems to be solved.

The present invention solves the problem by the manner of designing or configuring the gateway capable to performs processing at least a part of the data transmitted from the control signal receiving and retransmitting unit or the measurement component, that is to be carried out a part of the processing and calculating workload for server. The processing may be data aggregations, redundant data removing, for example. In several cases, some control algorithms may be provided and updated, for the gateway, by the server, the gateway may provide new control commands based on the initial control command of the user in some simple contexts. In addition, the gateway may provide a temporary control command based on the initial control command of the user before the server calculates to provide a new control command for reducing the control delay for the air conditioning apparatus from the time the user transmitting the control command. However, the present invention is not limited thereto.

As such, the solution of using the gateway to performs processing at least a part of the data supposedly improving the effective use of the network resources significantly, capable to increase the real time response and/or reducing the control delay. Moreover, with the current development of hardware technology the designing of the gateway is not complicated, while there are many existing gateways, or using existing ICs may be sufficient in configuration itself to carry out data processing and calculating, therefore the configuring for the gateways supposed to be convenient and easy.

In several embodiments, the air conditioning apparatus may operate according to the initial control command of the user right after the user transmits the control command, and after that the operation of the air conditioning apparatus may be adjusted by the energy-saving air conditioning monitoring and control system as described above.

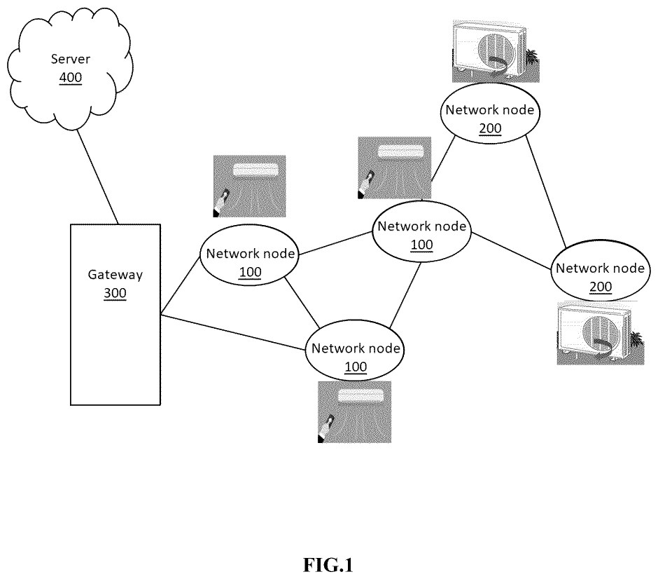

FIG. 1 is a schematic diagram view illustrating an energy-saving air conditioning monitoring and control system according to an embodiment of the present invention.

According to the embodiment, the energy-saving air conditioning monitoring and control system basically includes network nodes 100 and 200, a gateway 300, and a server 400.

The network nodes 100 are formed from the control signal receiving and retransmitting units. The control signal receiving and retransmitting unit is provided corresponding to at least one air conditioning apparatus, for receiving the air conditioning control signal from the conditioner control means, operated by users, sending to said air conditioning apparatus.

The network node 100 or the control signal receiving and retransmitting unit may be provided in the form of a conditioning face mounting device, mounted to a mounting position at a suitable surface in the vicinity of the location receiving air conditioning control signal from the conditioner control means of the corresponding air conditioning apparatus, for example mounting on the surface of the indoor unit, mounting on the wall near the indoor unit. However, the present invention is not limited thereto, any mounting position may be chosen, as long as it is capable to receiving the air conditioning control signal from the conditioner control means operated by users, and capable to retransmit the adjusted air conditioning control signal to the corresponding air conditioning apparatus.

Said air conditioning control signal may be a wired or wireless signal. An example of the wireless air conditioning control signal may be an infrared signal generated by the handheld remote control (infrared remote control) which is commonly used for most of the air conditioners or the air conditioning apparatuses.

The network nodes 200 are formed from the measurement components. The measurement component is provided corresponding to said at least one air conditioning apparatus, for measuring at least the instantaneous power and the electric energy consumption of the air conditioning apparatus.

The network node 200 or the measurement component is provided in the form of a compact measurement device, arranged at a suitable position for measuring the instantaneous power and the electric energy consumption of the corresponding air conditioning apparatus, for example at the outdoor unit (may be called as a condenser unit) of the air conditioning apparatus. However, the present invention is not limited thereto.

The measurement of the instantaneous power and the electric energy consumption may use any known method or means, for example a current sensor with a ring shape sleeve around the positive voltage wire of the circuit breaker or the contactor, for example.

As shown in FIG. 1, the network nodes 100 and 200 form a Mesh network architecture, data form any network node may be transmitted directly to the gateway 300, or via other network nodes to the gateway 300. After that, data from the gateway will be transmitted to the server 400.

According to a specific embodiment, the communication among the network nodes 100 and 200 using low energy Bluetooth technology. However, other alternative technologies replacing for Bluetooth may be also applied which is not out of the scope of the present invention, for example WiFi, Zigbee, LoRa, NFC, etc.

The communication between the gateways and the server 400 may be via a wireless communication, internet network, mobile network, satellite, or any other wired or wireless communications.

According to an embodiment, the energy-saving air conditioning monitoring and control system according to the present invention may be further configured to collect, store, and analyze the habits of the users and provide the air conditioning control information in consideration with the habits of the users. For example, when the user may tend to be continuous adjusting the temperature to be low, then supposing that the server may be at the beginning providing an algorithm to gradually increase the temperature, but it is suitable to the habit of said user, as for that other suitable algorithm may be applied. According to some additional examples, recommendations or warnings may be sent to said user to make the user aware of risks about the wasted energy use, a non-optimal mode, or the same according to standard criteria. Thereby helping the user raising awareness and having the habit of using the air conditioning apparatus more suitable.

According to an embodiment, the energy-saving air conditioning monitoring and control system according to the present invention may further configured to provide suggestions to the users at least one air conditioning mode among air conditioning modes which are pre-set and stored at the server, based on at least the habits of the user.

Herein, the habits of the users may be not limited at any specific habit or a category of habits, and may be analyzed, collected, and aggregated from many other different manners. Thus, there may provide an overall solution for monitoring and controlling the air conditioning apparatus in the best possible way.

According to one or several embodiments, the energy-saving air conditioning monitoring and control system according to the present invention may carry out automatically the controlling of the air conditioning apparatus adapted to the context.

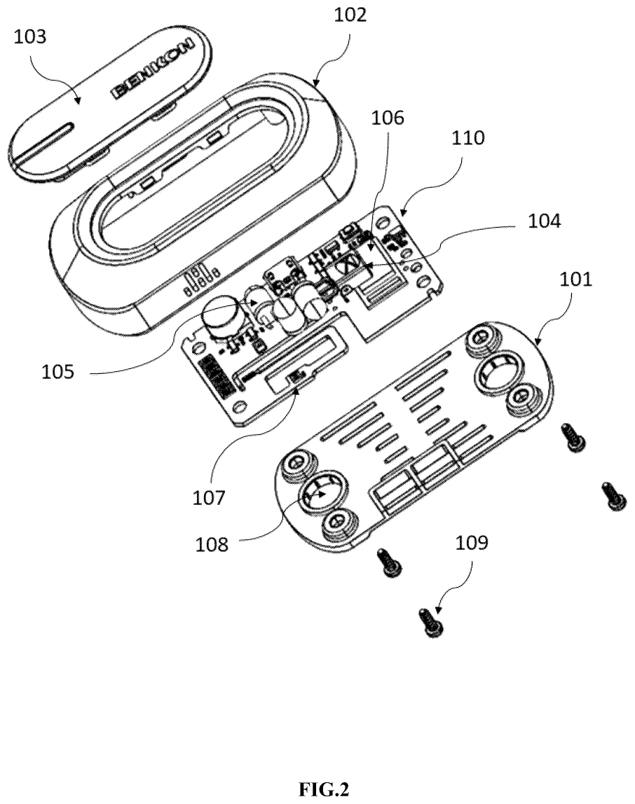

FIG. 2 shows a conditioning face mounting device taking a role as a control signal receiving and retransmitting unit or a network node 100 according to an embodiment of the present invention.

As shown in FIG. 2, the conditioning face mounting device may include a conditioning face mounting device base 101, a top cover 102 assembled with the conditioning face mounting device base 101 to form a housing containing components therein, an air conditioning control signal receiver 104 for receiving air conditioning control signal from the conditioner control means, an air conditioning control signal transmitter 105 for retransmitting the air conditioning control signal to the corresponding air conditioning apparatus, a communication module 106 for transceiving data bidirectional with network nodes of said Mesh network and/or said gateway, a sensor unit 107 for collecting at least surrounding environment data.

In general, information which are collected by the sensor unit 107 may be not of any limitation, for example there may collect data of the presence or the absence of human in the operating area of the air conditioning apparatus, data of temperature, humidity, for example.

As also shown in the drawing, said conditioning face mounting device having the conditioning face mounting device base 101 provided with a containing cavity 108 coupled with magnet member(s) (not shown in the drawing) so that the conditioning face mounting device base is attachable on a magnetic plate (not shown in the drawing) due to the magnetic attracting force. The magnetic plate is fixed on the expected mounting position by any manner, for example by glue/adhesive or double-sided adhesive tape for example, thus the conditioning face mounting device may be mounted to the mounting position in the manner that easily detachable. As mentioned above, the mounting position may be chosen optionally, as long as it is capable to receiving the air conditioning control signal from the conditioner control means operated by users, and capable to retransmit the adjusted air conditioning control signal to the corresponding air conditioning apparatus, for example the mounting position may be a mounting position on the surface of the indoor unit, a mounting position on the wall near the indoor unit, or the same.

The air conditioning control signal receiver 104, the air conditioning control signal transmitter 105, the communication module 106, the sensor unit 107 may be integrated on the same circuit board 110. The circuit board 110 together with the conditioning face mounting device base 101, and the top cover 102 may be coupled with each other by using screws 109, as such they may be easily disassembled.

An infrared filter 103 may be provided at the upper surface of the top cover 102. The infrared filter 103 is preferred to have a role of a cap of the top cover 102 so that the infrared filter 103 may be easily assembled to or disassembled from the top cover 102, for example using snap joints. By this way, may be easily and conveniently to approach and check electronic elements inside by disassembling the infrared filter 103 (the cap) from the top cover 102.

According to an embodiment, the conditioning face mounting device may be equipped with a power port and/or a data communication port, for example a USB Type C. However, the present invention is not limited thereto.

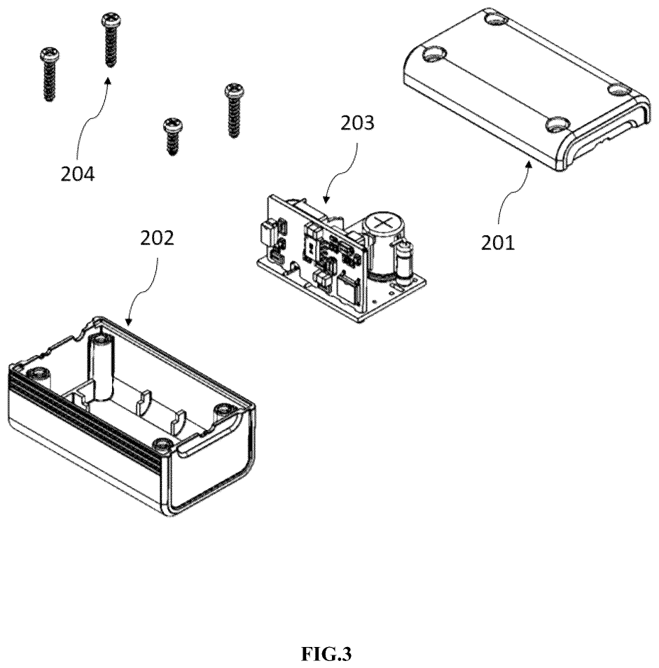

FIG. 3 shows a compact measurement device taking a role as a measurement component or a network node 200 according to an embodiment of the present invention.

As shown in FIG. 3, the compact measurement device may include a base portion 201 and a cover portion 202 assembled with the base portion 201 by screws 204 to form a housing containing components therein. A circuit board 203 with integrated functional units arranged inside the housing formed by the base portion 201 and the cover portion 202.

In general, the integrated functional units on the circuit board 203 may be provided appropriately to carry out the role of the network node 200, for example equipping with a communication module, these integrated functional units are basically known by the person skilled in the art and intended to be omitted to avoid redundancy.

The compact measurement device may be arranged near the position for carrying out the measurement, for example it may be clamp on the power source line. However, the present invention is not limited thereto.

In addition, the compact measurement device may be also equipped with sensors for collecting surrounding environment data if there is a need.

Although some embodiments have been described herein, and may accompanying with alternative or equivalent embodiments or specific exemplarily embodiment, using suitable descriptive terms and technical terms for person skilled in the art may understand and pertain the present invention. Therefore, the person skilled in the art may obviously implement modifications, equivalent arrangements, or variations based on the described embodiments. Therefore, all these modifications, equivalents, or variations fall within the protection scope of the claims appended, and the scope of the protection of the present invention is obviously not limited to contents and descripted embodiments but is defined in the following claims.

What is claimed is:

1. An energy-saving air conditioning monitoring and control system,
wherein the system supplemental equipped for one or many air conditioning apparatuses which work independently, in group, or in several various groups,
the system comprising:
at least one control signal receiving and retransmitting unit is provided corresponding to at least one air conditioning apparatus, for receiving an air conditioning control signal from a conditioner control means, operated by users, sending to said air conditioning apparatus;
at least one measurement component is provided corresponding to said at least one air conditioning apparatus, for measuring at least the instantaneous power and the electric energy consumption of the air conditioning apparatus;
at least one gateway for transceiving data bidirectional with the control signal receiving and retransmitting unit and the measurement component, for receiving at least the data of the air conditioning control signal from said conditioner control means and the data of the instantaneous power and the electric energy consumption of said air conditioning apparatus; and
a server for transceiving data bidirectional with said gateway;
wherein:
the control signal receiving and retransmitting unit and the measurement component are configured to perform the role of network nodes according to Mesh network architecture, wherein the control signal receiving and retransmitting unit or the measurement component transmitting or receiving data with the gateway directly or via intermediate nodes of the Mesh network,
the gateway performs processing at least a part of data transmitted from the control signal receiving and retransmitting unit or the measurement component, and transmits the processed data to the server, and forwards the remaining data transmitted from the control signal receiving and retransmitting unit or the measurement component which has not been processed to the server,
the server performs analysis and calculates based on at least data transmitted from the gateway for providing an air conditioning control information, and transmits the air conditioning control information to the corresponding control signal receiving and retransmitting unit via the gateway,
the control signal receiving and retransmitting unit relies on the air conditioning control information, transmitted from the server, to generate and retransmit an air conditioning control signal to the corresponding air conditioning apparatus,
wherein the air conditioning control signal retransmitted by the control signal receiving and retransmitting unit is basically adjusted in comparison with the air conditioning control signal transmitted by the conditioner control means aiming to achieve at least an energy-saving purpose.

2. The system according to claim 1, wherein said control signal receiving and retransmitting unit provided in the form of a conditioning face mounting device, mounted to a mounting position at a suitable surface in the vicinity of the location receiving the air conditioning control signal from the conditioner control means of the corresponding air conditioning apparatus.

3. The system according to claim 2, wherein said conditioning face mounting device comprising:
a conditioning face mounting device base,
a top cover assembled with the conditioning face mounting device base to form a housing containing components therein,
an air conditioning control signal receiver for receiving the air conditioning control signal from the conditioner control means,
an air conditioning control signal transmitter for retransmitting the air conditioning control signal to the corresponding air conditioning apparatus,
a communication module for transceiving data bidirectional with network nodes of said Mesh network and/or said gateway,
a sensor unit for collecting at least the surrounding environment data.

4. The system according to claim 3, wherein said conditioning face mounting device having the conditioning face mounting device base coupled with magnet member (s) so that the conditioning face mounting device base is attachable on a magnetic plate due to the magnetic attracting force,
wherein the magnetic plate is fixed on said mounting position, thus the conditioning face mounting device is mounted to the mounting position in the manner that easily detachable.

5. The system according to claim 4, wherein said the measurement component is provided in the form of a compact measurement device, arranged at a suitable position for measuring the instantaneous power and the electric energy consumption of the corresponding air conditioning apparatus.

6. The system according to claim 5, wherein the measurement component in the form of the compact measurement device including a base portion, and a cover portion assembled with the base portion to form a housing containing components therein.

7. The system according to claim 1, wherein the system is further configured to collect, store, and analyze habits of users and provide the air conditioning control information in consideration with the habits of users.

8. The system according to claim 7, wherein the system is further configured to provide suggestions to users at least one air conditioning mode among air conditioning modes which are pre-set and stored at the server, based on at least the habits of users.
